(19) United States
(12) Patent Application Publication
(10) Pub. No.: US 2022/0301760 A1
(43) Pub. Date: Sep. 22, 2022

(54) TRANSFORMER

(71) Applicant: Ururaki Inc., Mississauga (CA)

(72) Inventors: Mahdi S. Atteia, Mississauga (CA); Drew A. Camilucci, Mississauga (CA); Mhamad Salih, Mississauga (CA)

(73) Assignee: Ururaki Inc., Mississauga (CA)

(21) Appl. No.: 17/698,251

(22) Filed: Mar. 18, 2022

Related U.S. Application Data
(60) Provisional application No. 63/163,604, filed on Mar. 19, 2021.

(51) Int. Cl. H01F 27/28; H01F 27/32

(52) U.S. Cl. CPC H01F 27/2804; H01F 27/324; H01F 27/323; H01F 2027/2809; H01F 27/24

(57) ABSTRACT

A transformer comprises a core formed of magnetic material; a primary printed circuit board (PCB) winding stack surrounding one limb of the core; and a secondary PCB winding stack surrounding another limb of the core.

### CROSS-REFERENCE TO RELATED APPLICATION

This application claims the benefit of U.S. Provisional Application Ser. No. 63/163,604 filed on Mar. 19, 2021, the entire content of which is incorporated herein by reference. This application is also related to U.S. Provisional Application Ser. No. 63/052,091 filed on Jul. 15, 2020 and titled DC to DC Boost Converter, the entire content of which is incorporated herein by reference.

### FIELD

The subject disclosure relates to a transformer.

### BACKGROUND

Transformers are well known in the art and are used in a wide range of applications to step-up or step-down voltage from one level to another, to suit the applications at hand. FIG. 1 shows a typical transformer 100 comprising a core 102 formed of magnetic material, a primary winding or coil 104 that receives an input voltage and is wound around one limb of the core 102 and a secondary winding or coil 106 that provides a stepped-up or stepped-down output voltage (depending on the turns ratio of the primary to secondary windings) and is wound around an opposite limb of the core 102. During operation, the transformer 100 is subject to energy losses that can be classified as load or copper losses (associated with the resistivity of the primary and secondary windings) and no-load or core losses (associated with the core of the transformers). These losses result in the generation of internal heat that limits transformer operation. The industry standard is to maintain heat generation under 100 mW/cm³.

To improve transformer efficiency, it is typically desired to increase the power output of the transformer while minimizing the core and copper losses. Historically, core losses have been minimized by making the core out of a stack of insulated laminations rather than of unitary construction and by using soft magnetic materials with high magnetic permeability. In order to increase power output, the cross-sectional area of the core can be increased. For example, doubling the volume of the core increases power output by a factor of 1.41. Increasing core size however comes at a cost as larger primary and secondary windings are required resulting in an increase in copper losses.

Depending on environment, the size of transformers may vary significantly. For example, in electric power grid environments, transformers are used to step-up the voltage of generated electricity for transmission over medium and high voltage distribution lines as well as to step-down the voltage of electricity carried over medium and high voltage distribution lines for supply to loads on the electric power grids. These transformers are usually large, heavy, expensive to manufacture, and have high copper and core losses. In the case of DC power generating plants, three-phase transformers are typically custom made for each DC power generating plant. This makes scaling the power output generated by such DC power generating plants expensive as new custom transformers may be required.

Transformers are also used in many household and commercial applications and in power electronics. High frequency switch-mode power supplies that employ electronic DC to DC converters are widely used in many electronic products and include transformers to step-up DC input voltages from one level to another. These switch-mode power supplies are particularly useful in fields such as X-ray machines, plasma generators, and particle accelerators where both high voltage and high power are required. Transformers for these applications that are currently available can produce up to 60 kV at a maximum power of 2 kW. While it is often desirable to achieve higher output voltages and higher power output, the design of conventional transformers used in power electronics applications has been a limiting factor.

In conventional high frequency switch-mode power supplies, due to the skin effect, at higher frequencies the resistance of the conductors used in their transformers increases as current tends to flow only in the circumference of the conductors. This means that the current density is greater towards the conductor surfaces and decreases exponentially deeper within the conductors. The skin effect limits the effective cross-sectional area available for conduction and as a result, increases the effective resistance of the conductors and thus, increases copper losses.

To minimize skin effect at high frequencies, Litz wires are commonly used. Litz wires comprise many thin copper wire strands that are individually insulated and twisted together in a specified pattern. This serves to ensure that the proportion of overall strand length at the wire exteriors is distributed equally among each strand. As a result, the Litz wires function as low-resistance, high-current conductors at high frequencies. Litz wires however require a relatively large volume, and hence, are not practical in compact applications.

As will be appreciated, improvements in transformer design are desired. It is therefore an object to provide a novel transformer.

This background serves only to set a scene to allow a person skilled in the art to better appreciate the following brief and detailed descriptions. None of the above discussion should necessarily be taken as an acknowledgement that this discussion is part of the state of the art or is common general knowledge.

### BRIEF DESCRIPTION

It should be appreciated that this brief description is provided to introduce a selection of concepts in a simplified form that are further described below in the detailed description. This brief description is not intended to be used to limit the scope of the claimed subject matter.

Accordingly in one aspect there is provided a transformer comprising: a core formed of magnetic material; a primary printed circuit board (PCB) winding stack surrounding one limb of the core; and a secondary PCB winding stack surrounding another limb of the core.

In one or more embodiments, the primary PCB winding stack comprises a plurality of stacked primary PCB winding assemblies electrically connected in series and the secondary PCB winding stack comprises a plurality of stacked secondary PCB winding assemblies electrically connected in series.

In one or more embodiments, each primary PCB winding assembly comprises a plurality of generally planar winding layers electrically connected in parallel. The winding layers of each primary PCB winding assembly may be configured to form a single turn coil.

In one or more embodiments, each primary PCB winding assembly comprises a plurality of electrically insulating material layers on which the winding layers are disposed. The winding layers may be substantially identical and have a high surface to volume ratio.

In one or more embodiments, the transformer may further comprise solder mask layers overlying opposite major surfaces of each stacked primary PCB winding assembly.

In one or more embodiments, electrically insulating layers may be interposed between each pair of primary PCB winding assemblies in the primary PCB winding stack. An electrically insulating layer may be disposed on the uppermost and lowermost primary PCB winding assembly in the primary PCB winding stack.

In one or more embodiments, each secondary PCB winding assembly comprises a plurality of generally planar winding layers and wherein the winding layers are electrically connected in series. The winding layers of each secondary PCB winding assembly may be configured to form a plural turn coil.

In one or more embodiments, each secondary PCB winding assembly comprises a core layer formed of electrically insulating material and having a generally planar conductive winding layer on each major surface thereof.

In one or more embodiments, the transformer further comprises solder mask layers overlying opposite major surfaces of each stacked secondary PCB winding assembly.

In one or more embodiments, electrically insulating layers interposed between each pair of secondary PCB winding assemblies in the secondary PCB winding stack. An electrically insulating layer may be disposed on the uppermost and lowermost secondary PCB winding assembly in the secondary PCB winding stack.

### BRIEF DESCRIPTION OF THE DRAWINGS

Embodiments will now be described by way of example only with reference to the accompany drawings in which:

FIG. 1 is a schematic diagram of a conventional transformer;

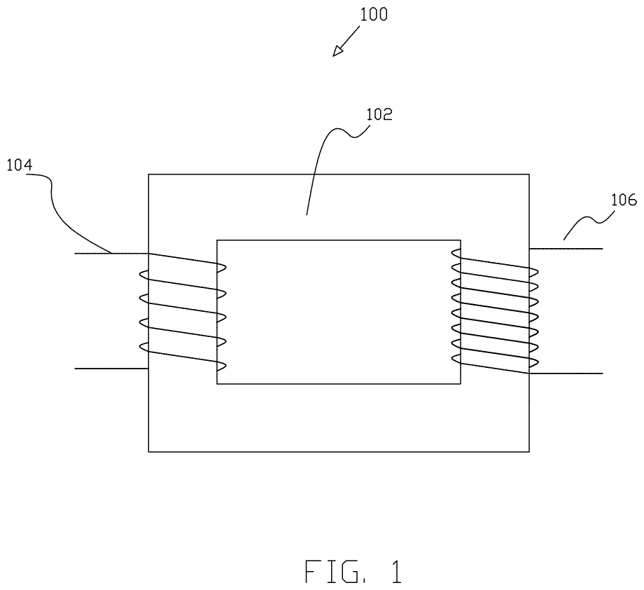

FIG. 2 is a perspective view taken from above and from the side of a transformer in accordance with the subject disclosure;

FIG. 3 is a cross-sectional view of a primary PCB winding stack forming part of the transformer of FIG. 2;

FIG. 4 are plan views of a primary PCB winding assembly forming part of the primary PCB winding stack of FIG. 3;

FIG. 5 is a cross-sectional view of a secondary PCB winding stack forming part of the transformer of FIG. 2; and

FIG. 6 are plan views of a secondary PCB winding assembly forming part of the secondary PCB winding stack of FIG. 4.

### DETAILED DESCRIPTION

The foregoing summary, as well as the following detailed description of certain examples will be better understood when read in conjunction with the accompanying drawings. As used herein, an element, feature, component, structure etc. introduced in the singular and preceded by the word “a” or “an” should be understood as not necessarily excluding the plural of the elements, features, components, structures etc. Further, references to “one example” or “one embodiment” are not intended to be interpreted as excluding the existence of additional examples or embodiments that also incorporate the described elements, features, components, structures etc.

Reference herein to “example” means that one or more feature, structure, element, component, characteristic and/or operational step described in connection with the example is included in at least one embodiment and/or implementation of the subject matter according to the subject disclosure. Thus, the phrases “an example,” “another example,” and similar language throughout the subject disclosure may, but do not necessarily, refer to the same example. Further, the subject matter characterizing any one example may, but does not necessarily, include the subject matter characterizing any other example.

Unless explicitly stated to the contrary, examples or embodiments “comprising” or “having” or “including” an element, feature, component, structure etc. or a plurality of elements, features, components, structures etc. having a particular property may include additional elements, features, components, structures etc. not having that property. Also, it will be appreciated that the terms “comprises”, “has”, “includes” means “including but not limited to” and the terms “comprising”, “having” and “including” have equivalent meanings. As used herein, the term “and/or” can include any and all combinations of one or more of the associated listed elements, features, components, structures etc.

Reference herein to “configured”, “operative”, and “adapted” denote actual states that fundamentally tie the element, feature, component, structure etc. to the physical characteristics of the element, feature, structure, component, structure etc. preceding the phrase “configured to”, “operative to”, and “adapted to”. Thus, “configured”, “operative”, and “adapted” means that the element, feature, structure, component, structure etc. is designed and/or intended to perform a given function. Thus, the use of the term “configured”, “operative”, and “adapted” should not be construed to mean that a given element, feature, structure, component, structure etc. is simply “capable of” performing a given function but that the element, feature, structure, component, structure etc. is specifically selected, created, implemented, utilized, and/or designed for the purpose of performing the function.

It will be understood that when an element, feature, component, structure etc. is referred to as being “on”, “attached” to ‘connected’ to, “coupled” with, “contacting” etc. another element, feature, component, structure etc. that element, feature, component, structure etc. can be directly on, attached to, connected to, coupled with or contacting the other element, feature, component, structure etc. feature or intervening elements, features, components, structures etc. may also be present. In contrast, when an element, feature, component, structure etc. is referred to as being “directly” on, “directly attached” to, “directly connected” to, “directly coupled” with, “directly contacting” etc. another element, feature, component, structure etc. there are no intervening elements, features, components, structures etc. present. Similarly, it will be understood that when an element, feature, component, structure etc. is referred to as being “directly between” other elements, features, components, structures etc. that element, feature, component, structure etc. Is positioned between the other elements, features, components, structures etc. without any intervening elements, features, components, structures, etc. In contrast, when an element, feature, component, structure etc. is referred to as being “between” other elements, features, components, structures etc. that element, feature, component, structure etc. is positioned between the other elements, features, components, structures etc. but intervening elements, features, components, structures etc. may also be present.

It will be understood that spatially relative terms such as “bottom”, “under”, “below”, “lower”, “over”, “upper”, “top”, ““front”, “back”, “side” and the like, may be used herein for ease of describing the relationship of an element or feature to another element or feature as depicted in the figures. The spatially relative terms can however, encompass different orientations in use or operation in addition to the orientation depicted in the figures.

As used herein, the terms “approximately”, “about” “generally”, “substantially” etc. represent an amount or characteristic close to the stated amount or characteristic that still performs the desired function or achieves the desired result. For example, the terms “approximately” and “about” in reference to a stated amount include amounts that are within engineering or design tolerances of the stated amount that would be readily appreciated by a person skilled in the art. Similarly, for example, the term “substantially” in reference to a stated characteristic of an element, feature, component, structure etc. includes elements, features, components, structures etc. that nearly completely provide the stated characteristic, and the term “generally” in reference to a stated characteristic of an element, feature, component, structure etc. includes elements, features, components, structures etc. that predominately provide the stated characteristic.

Unless otherwise indicated, the terms “first”, “second” etc. are used herein merely as labels, and are not intended to impose ordinal, positional, or hierarchical requirements on the elements, features, components, structures etc. to which these terms refer. Moreover, reference to a “second” element, feature, component, structure etc. does not require or preclude the existence of a lower-numbered element, feature, component, structure etc. (e.g., a “first” element) and/or a higher-numbered element, feature, component, structure etc. (e.g., a “third” element).

In the subject disclosure, a transformer is described comprising a core formed of magnetic material, a primary printed circuit board (PCB) winding stack surrounding one limb of the core, and a secondary PCB winding stack surrounding another limb of the core. The transformer is of a compact form, exhibits low losses and can be manufactured using standardized PCB manufacturing technologies to achieve a low cost product while being particularly suited for use in high-frequency, high-power applications. The transformer is capable of handling 83 A at 250 kHz and generating medium voltage direct current (MVDC) power of about 33 kV from 600V to 1 kV high frequency input. Because the transformer can be manufactured using standardized PCB manufacturing technologies, the transformer can be manufactured at low cost, allowing it to be readily mass produced and making it scalable for use in 2 and 3 digit Mega-Watt DC power plants.

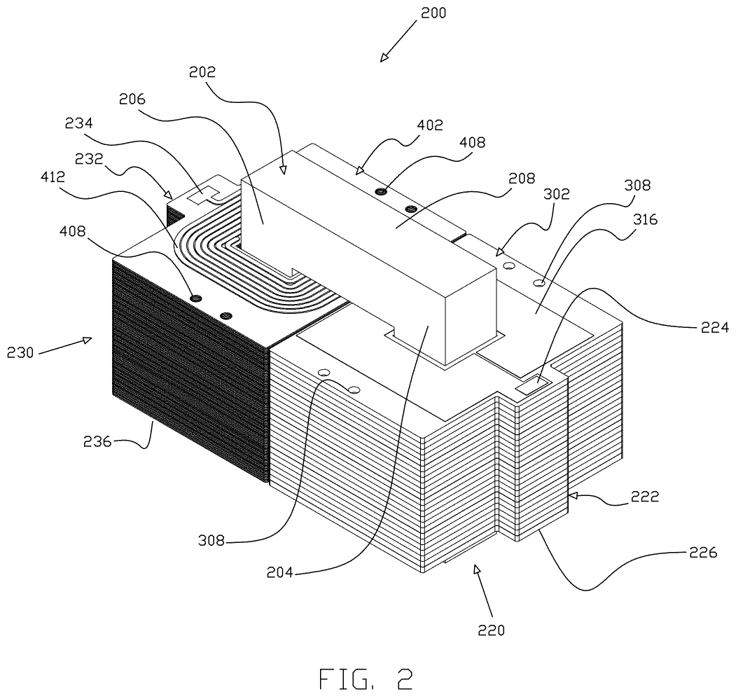

Turning now to FIG. 2, an exemplary transformer is shown and is generally identified by reference numeral 200. In this embodiment, the transformer 200 is suitable for stepping-up high frequency, lower voltage input to high frequency, medium voltage or high voltage output. The transformer 200 comprises a core 202 having a UU configuration. The core 202 is formed of magnetic material that is suitable for high frequency operation and capable of accommodating 50 kW boost power at 250 kHz. In this embodiment, the core 202 is formed of ferrite ceramic material although those of skill in the art will appreciate that other ferrite or magnetic material may be employed. Each U-shaped core element of the core 202 defines a pair of limbs 204 and 206, respectively, joined by a bight 208. A primary coil or winding 220 surrounds the limbs 204 of the core 202. The primary coil 220 has a rectangular column 222 projecting from one side thereof. Input terminals 224 and 226 configured to connect to an input voltage source are provided at opposite ends of the column 222. A secondary coil or winding 230 surrounds the limbs 206 of the core 202. The secondary coil 230 has a rectangular column 232 projecting from one side thereof. Output terminals 234 and 236 configured to connect to a load are provided at opposite ends of the column 232.

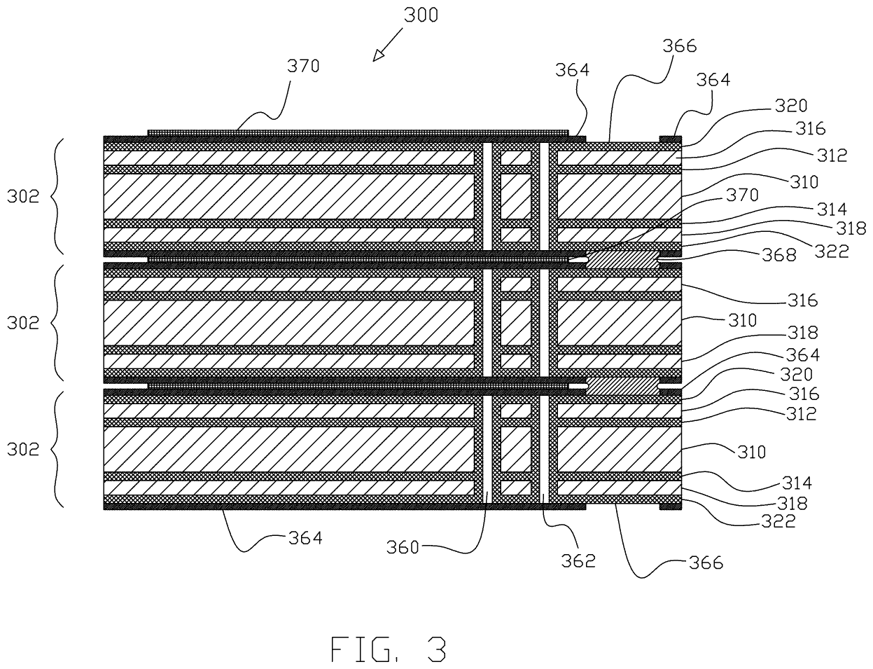

Turning now to FIGS. 2 to 4, the primary coil 220 is better illustrated. As can be seen, primary coil 220 comprises a primary PCB winding stack 300 comprising a plurality of primary PCB winding assemblies 302 stacked one atop the other. For ease of illustration only, the primary PCB winding stack 300 is shown in FIG. 3 as comprising three (3) primary PCB winding assemblies 302, namely an upper primary PCB winding assembly, an intermediate primary PCB winding assembly, and a lower primary PCB winding assembly. Typically, the primary PCB winding stack 300 will comprise a significant number of primary PCB winding assemblies 302 (e.g. twenty four (24)) with the number of primary PCB winding assemblies 302 in the primary PCB winding stack 300 being selected depending on the environment in which the transformer 200 is employed.

Each primary PCB winding assembly 302 is generally rectangular in plan and has a generally central, square aperture or cut-out 304 provided therethrough and a generally rectangular tab 306 forming part of the column 222 projecting from one side thereof. The apertures 304 provided through the primary PCB winding assemblies 302 are in general alignment thereby to define the passage in the primary coil 220 through which the limbs 204 of core 202 pass. A pair of laterally spaced mounting holes 308 is also provided through each primary PCB winding assembly 302 adjacent opposite side edges thereof. The mounting holes 308 provided through the primary PCB winding assemblies 302 are in general alignment thereby to define passages configured to receive fasteners in the form of nuts and bolts or the like (not shown) that hold the primary PCB winding stack 300 securely together and maintain the primary PCB winding assemblies 302 in alignment.

Each primary PCB winding assembly 302 comprises a central, electrically insulating core layer 310 formed from FR4 or other suitable material. The core layer 310 in this embodiment has a thickness of approximately 0.5 mm and has a high dielectric strength. Electrically conductive, upper and lower intermediate winding layers 312 and 314, respectively, are provided on the top and bottom major surfaces of the core layer 310. An electrically insulating, upper layer 316 formed of pre-peg FR4 or other suitable material having a thickness of approximately 0.12 mm is provided over the upper intermediate winding layer 312 and the exposed portion of the top major surface of the core layer 310. An electrically insulating lower layer 318 formed of pre-peg FR4 or other suitable material having a thickness of approximately 0.12 mm is provided over the lower intermediate winding layer 318 and the exposed portion of the bottom major surface of the core layer 310. The dielectric strength of the core layer 310 and the upper and lower layers 316 and 318 are sufficient to sustain an electric field intensity of up to 200 kV/cm (about 10 kV per 0.5 mm). An electrically conductive, upper winding layer 320 is provided on the upper major surface of the upper layer 316 and an electrically conductive, lower winding layer 322 is provided on the lower major surface of the lower layer 318. As a result, each PCB winding assembly 302 comprises four (4) winding layers 312, 314, 320, and 322. Those of skill in the art will appreciate that the thicknesses of the core layer 310 and upper and lower layers 316 and 318 may vary depending on manufacturing constraints.

In this embodiment, each winding layer 312, 314, 320, and 322 comprises a generally planar, conductive trace formed of copper or other suitable conductive material that forms a single (i.e. one (1)) turn, square or rectangular coil encircling the aperture 304. In this embodiment, each conductive trace has a width of approximately 22 mm, a length of approximately 207 mm, a resistance of approximately 0.00110 ohms, and a thickness of approximately 35 μm. As will be appreciated, the layout of each conductive trace gives the conductive trace a high surface to volume ratio.

The ends of the upper winding layer 320 are spaced apart defining an interruption 332 extending from an interior edge of the upper layer 316 that bounds the aperture 304, to the tab 306. The exterior edges of the upper winding layer 320 are inwardly spaced from the outer edges of the upper layer 316 and the interior edges of the upper winding layer 320 are spaced from the interior edges of the upper layer 316 that bound the aperture 304 creating an outline edge clearance. The upper winding layer 320 is also configured to define a wing 334 extending from one end thereof and that overlies a portion of the tab 306. The exterior edges of the wing 334 are inwardly spaced from the outer edges of the tab 306 creating an outline edge clearance. A surface mount pad 340 formed of gold-plated copper or other suitable conductive material is provided on the wing 334.

The lower winding layer 322 has a layout that is basically the same as the upper winding layer 320. Thus, the ends of the lower winding layer 322 are spaced apart defining an interruption 342 extending from an interior edge of the lower layer 318 that bounds the aperture 304, to the tab 306. The exterior edges of the lower winding layer 322 are inwardly spaced from the outer edges of the lower layer 318 and the interior edges of the lower winding layer 322 are spaced from the interior edges of the lower layer 318 that bound the aperture 304 creating an outline edge clearance. The lower winding layer 322 is also configured to define a wing 344 extending from one end thereof and that overlies a portion of the tab 306. The exterior edges of the wing 344 are inwardly spaced from the outer edges of the tab 306 creating an outline edge clearance. A surface mount pad 350 formed of gold-plated copper or other suitable conductive material is provided on the wing 344.

The upper and lower intermediate winding layers 312 and 314, respectively, also have layouts that are similar to the layouts of the upper and lower winding layers 320 and 322. Thus, the ends of the upper and lower intermediate winding layers 312 and 314 are spaced apart defining interruptions 352 extending from an interior edge of the core layer 310 that bounds the aperture 304, to the tab 306. The exterior edges of the upper and lower intermediate winding layers 312 and 314 are inwardly spaced from the outer edges of the core layer 310 and the interior edges of the upper and lower intermediate winding layers 312 and 314 are spaced from the interior edges of the core layer 310 that bound the aperture 304 creating an outline edge clearance. The upper and lower intermediate winding layers 312 and 314 are however devoid of wings.

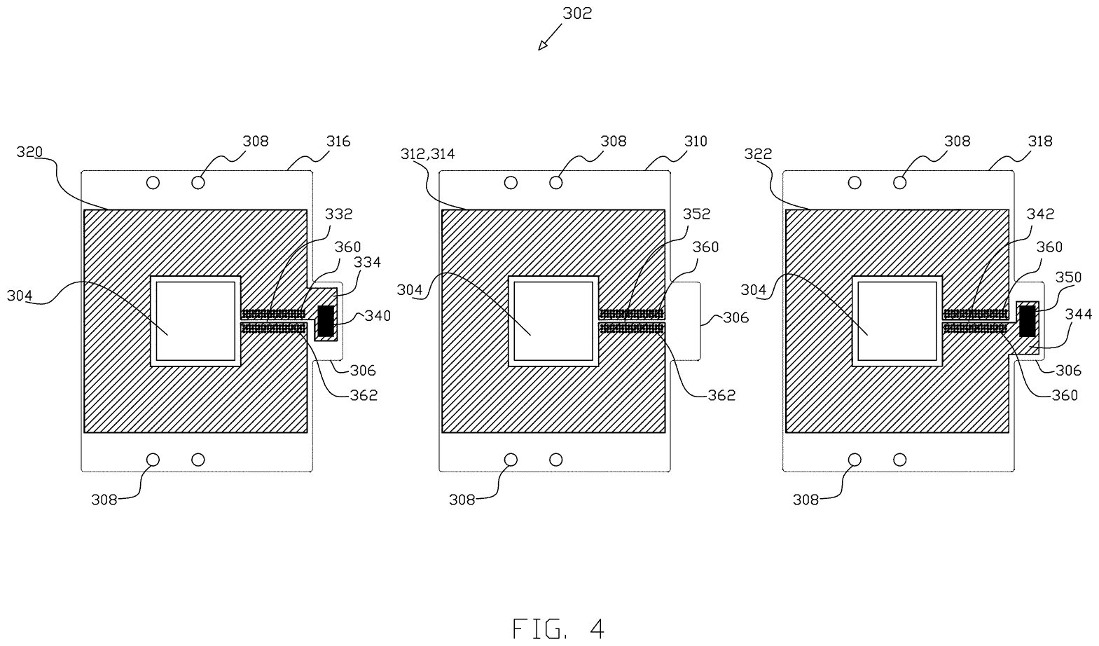

A pair of through-hole via arrays 360 and 362, each comprising a plurality of rows of spaced through-holes that are plated with conductive material formed of copper or other suitable material, is provided in each primary PCB winding assembly 302. For ease of illustration, the via arrays 360 and 362 are represented as a pair of plated through passages in FIG. 4. The via arrays 360 and 362 are positioned so that each via array extends along a respective one end of each of the winding layers 312, 314, 320, and 322. The plated through-holes of the via arrays 360 and 362 provide physical and electrical connections between (i) the upper winding layer 320 and the upper intermediate winding layer 314, (ii) the upper and lower intermediate winding layers 314 and 316, and (iii) the lower intermediate winding layer 316 and the lower winding layer 322. Thus, by virtue of the interruptions, 332, 342, and 352, the via arrays 360 and 362 provide a parallel electrical connection between the winding layers 312, 314, 320, and 322 resulting in each primary PCB winding assembly 302 having only one turn despite being comprised of multiple winding layers. Also, the planar configuration of the winding layers 312, 314, 320, and 322 reduces winding resistance of the primary PCB winding assembly 302 by taking advantage of the skin effect, which would otherwise be problematic when running the transformer 200 at high frequencies (e.g. 100 kHz to 250 kHz).

A solder mask 364 having a thickness of approximately 20 μm is provided over the top and bottom of each primary PCB winding assembly 302. Windows 366 are provided in the solder masks 364 adjacent the tab 306 to expose the surface mount pads 340 and 350. The solder masks 364 serve to protect the PCB winding assemblies 302 from corrosion and oxidation.

As mentioned above, the primary PCB winding assemblies 302 are arranged one atop the other to form the primary PCB winding stack 300. Thus, for each stacked pair of adjacent primary PCB winding assemblies 302 in the primary PCB winding stack 300, the surface mount pad 340 of the lower PCB winding assembly 302 in the pair is in proximity to and faces the surface mount pad 350 of the upper PCB winding assembly 302 in the pair. Solder bridges 368, or other suitable electrical connections electrically, connect the facing surface mount pads 340 and 350 to electrically connect the primary PCB winding assemblies 302 in the primary PCB winding stack 300 electrically in series. The exposed surface mount pad 340 of the uppermost primary PCB winding assembly 302 in the primary PCB winding stack 300 defines input terminal 224 and the exposed surface mount pad 350 of the lowermost primary PCB winding assembly 302 in the primary PCB winding stack 300 defines input terminal 226.

An insulating film or layer 370 formed of polyimide film (e.g. kapton tape) or other suitable material having a high dielectric strength and a high thermal conductivity is provided between the facing solder masks 364 of each pair of adjacent primary PCB winding assemblies 302. An insulating film 370 is also provided on the solder mask 364 over the top of the uppermost primary PCB winding assembly 302 in the primary PCB winding stack 300 and on the solder mask 364 over the bottom of the lowermost primary PCB winding assembly 302 in the primary PCB winding stack 300. The insulating films 370 each have a thickness of approximately 68 μm and serve to electrically insulate the primary PCB winding assemblies 302 from one another. The insulating films 370 may further function as a heat sink by drawing resistive heat generated at the winding layers towards the side edges of the primary PCB winding stack 300. Although the insulating films 370 are shown as only covering portions of the solder masks 364, this is for ease of illustration only. The insulating films 370 cover the entireties of the solder masks 364.

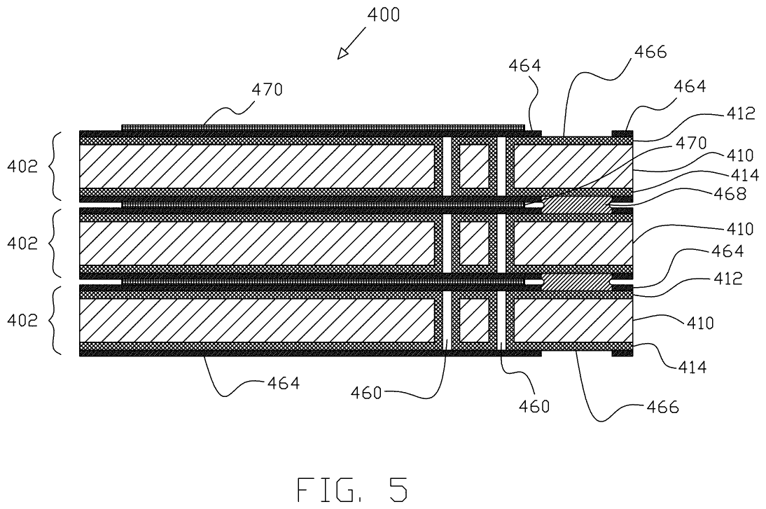

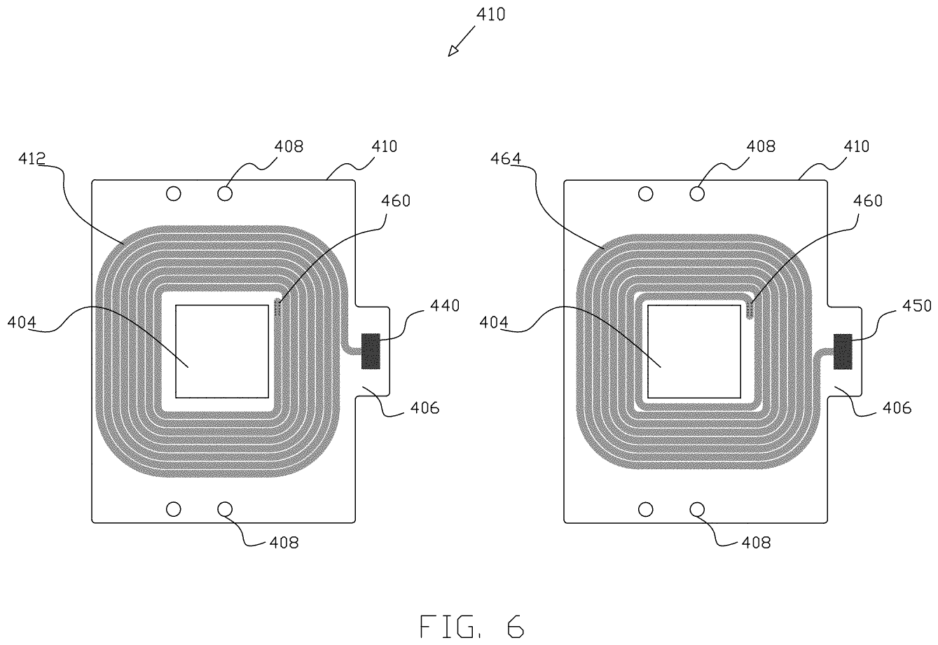

Turning now to FIGS. 2, 5, and 6, the secondary coil 230 is better illustrated. As can be seen, secondary coil 230 comprises a secondary PCB winding stack 400 comprising a plurality of secondary PCB winding assemblies 402 stacked one atop the other. For ease of illustration only, the secondary PCB winding stack 400 is shown in FIG. 5 as comprising three (3) secondary PCB winding assemblies 402 stacked one atop the other, namely an upper secondary PCB winding assembly, an intermediate secondary PCB winding assembly, and a lower secondary PCB winding assembly. Typically, the secondary PCB winding stack 400 will comprise a significant number of secondary PCB winding assemblies 402 (e.g. ninety (90)) with the number of secondary PCB winding assemblies 402 in the stack 400 being selected depending on the environment in which the transformer is employed.

Each secondary PCB winding assembly 402 is generally rectangular in plan and has generally central, square aperture or cut-out 404 provided therethrough and a generally rectangular tab 406 that forms part of the column 232 projecting from one side thereof. The apertures 404 provided through the secondary PCB winding assemblies 402 in the secondary PCB winding stack 400 are in substantial alignment thereby to define the passage in the secondary coil 230 through which the limbs 206 of core 202 pass. A pair of laterally spaced mounting holes 408 is also provided through the secondary PCB winding assemblies adjacent opposite side edges thereof. The mounting holes 408 provided through the secondary PCB winding assemblies 402 in the secondary PCB winding stack 400 are in substantial alignment thereby to define passages configured to receive fasteners in the form of nuts and bolts or the like (not shown) that hold the secondary PCB winding stack 400 securely together and maintain the secondary PCB winding assemblies 402 in alignment.

Each PCB winding assembly 402 comprises an electrically insulating core layer 410 formed from FR4 or other suitable material. The core layer 410 in this embodiment has a thickness of approximately 0.5 mm and has a high dielectric strength sufficient to sustain an electric field intensity of up to 200 kV/cm (about 10 kV per 0.5 mm). Electrically conductive, upper and lower winding layers 412 and 414 having similar layouts are provided on the top and bottom major surfaces of the core layer 410.

In this embodiment, each winding layer 412 and 414 is in the form of a generally planar, conductive trace formed of copper or other suitable conductive material that forms a plural turn coil encircling the aperture 404. In this embodiment, each conductive trace forms an eight (8) turn, square or rectangular coil that encircles the aperture 404. Also, in this embodiment, each winding layer 412 and 414 has a width of approximately 2 mm, a length of approximately 3074 mm, a resistance of approximately 0.750 ohms, and a thickness of approximately 35 μm.

The exterior edges of the each winding layer 412 and 414 are inwardly spaced from the outer edges of the core layer 410 and the interior edges of each winding layer 412 and 414 are spaced from the interior edges of the core layer 410 that bound the aperture 404 creating an outline edge clearance. The outer end of each winding layer 412 and 414 terminates at a respective surface mount pad 440 and 450 formed of gold-plated copper or other suitable conductive material provided on the tab 406. The exterior edges of the surface mount pads 440 and 450 are inwardly spaced from the outer edges of the tab 406 creating an outline edge clearance.

A through-hole via array 460 comprising a plurality of rows of spaced through-holes that are plated with conductive material formed of copper or other suitable material, is provided in the secondary PCB winding assembly 402. For ease of illustration, the via array 460 is represented as a pair of plated through-passages in FIG. 5. The via array 460 is positioned adjacent the interior ends of the winding layers 412 and 414. The plated through-holes of the via array 460 provide a series electrical connection between the ends of the winding layers 412 and 414 thereby to yield a sixteen (16) turn square coil on each secondary PCB winding assembly 402.

A solder mask 464 having a thickness of approximately 20 μm is provided over the top and bottom of the secondary PCB winding assembly 402. Windows 466 are provided in the solder masks 464 adjacent the tab 406 to expose the surface mount pads 440 and 450. The solder masks 464 serve to protect the PCB winding assembly 402 from corrosion and oxidation.

As mentioned above, the secondary PCB winding assemblies 402 are arranged one atop the other to form the secondary PCB winding stack 400. Thus, for each stacked pair of adjacent secondary PCB winding assemblies 402 in the secondary PCB winding stack 400, the surface mount pad 440 of the lower secondary PCB winding assembly 402 in the pair is in proximity to and faces the surface mount pad 450 of the upper secondary PCB winding assembly 402 in the pair. Solder bridges 468, or other electrical suitable connections, electrically connect the facing surface mount pads 440 and 450 to electrically connect the adjacent pair secondary PCB winding assemblies 402 electrically in series. The exposed surface mount pad 440 of the uppermost secondary PCB winding assembly 402 in the secondary PCB winding stack 400 defines output terminal 234 and the exposed surface mount pad 450 of the lowermost secondary PCB winding assembly 402 in the secondary PCB winding stack 400 defines output terminal 236.

An insulating film or layer 470 formed of polyimide film (e.g. kapton tape) or other suitable material having a high dielectric strength and a high thermal conductivity is provided between the facing solder masks 464 of each pair of adjacent secondary PCB winding assemblies 402. An insulating film 470 is also provided on the solder mask 464 over the top of the uppermost secondary PCB winding assembly 402 in the secondary PCB winding stack 400 and on the solder mask 464 over the bottom of the lowermost secondary PCB winding assembly 402 in the secondary PCB winding stack 400. The insulating films 470 each have a thickness of approximately 68 μm and serve to electrically insulate the secondary PCB winding assemblies 402 from one another. The insulating films 470 also function as a heat sink by drawing resistive heat generated at the conductive traces 434 and 464 towards the side edges of the secondary PCB winding stack 400. Although the insulating films 470 are shown as only covering portions of the solder masks 464, this is for ease of illustration only. The insulating films 470 cover the entireties of the solder masks 484.

As will be appreciated by those of skill in the art, the primary and secondary PCB winding stacks 300 and 400, respectively, are of a compact form giving the transformer a compact design. In this embodiment, the transformer has a length of about 7 inches, a width of about 4 inches and a height of about 4.5 Inches. Also, the makeup of the primary and secondary PCB winding stacks 300 and 400, respectively, allow them to be manufactured using standardized PCB manufacturing technologies. This allows the transformer 200 to be manufactured at low cost and readily mass produced making it scalable for use in 2 and 3 digit Mega-Watt DC power plants.

As mentioned previously, the transformer 200 is particularly suited for use in high-frequency, high power applications. For example, the transformer 200 may be employed in DC to DC boost converters such as that described in above-incorporated U.S. Provisional Application No. 63/052,091. In such high-frequency, high-power applications, the transformer is configured to deliver boost power between about 50 kW and about 200 kW at frequencies in the range of about 100 kHz to about 250 kHz and to step-up a high frequency DC 600V to 1 kV input voltage to a high frequency 33 kV output voltage while exhibiting low losses.

To deal with heat dissipation, rather than deploying a single larger transformer rated to suit the application, a plurality of smaller transformers 200, typically three (3) or four (4) transformers, are electrically connected in parallel to form a transformer assembly rated to suit the application. This configuration allows the total core volume that is needed for higher power capacity to be achieved while maintaining winding length so as to avoid increased winding resistance and while maintaining core surface area for natural cooling. Another advantage of this configuration is that, regardless of core size, the total number of turns will remain the same. This avoids increasing core volume which results in longer coil lengths for the turns around the core, which in turn increases copper losses. The parallel transformer configuration also allows the current in each transformer to be reduced leading to lower resistive losses. This configuration further allows for easy scaling, in that additional transformers can be easily added providing for increased power output without disrupting the existing configuration.

Although the core has been described and illustrated as having a UU configuration, those of skill in the art will appreciate that other core configurations may be employed. For example, the core may alternatively have a UI, UR, toroidal, EI, EC, ER, EP, EER, EFD, ETD, planar EI, block, pot, RS/DS, PQ, or RM configuration.

Although the core has been described as being formed of ferrite ceramic material, those of skill in the art will appreciate that other ferrite material such as L, R, P, F, T, J, W, C, E, and V may be employed. Furthermore, although the core has been described as being formed of ferrite material, those of skill in the art will appreciate that the core may be formed of other magnetic material. For example, the core may be formed of amorphous metal, amorphous steel, carbonyl iron, laminated iron sheets, silicon steel, powdered metals, special alloys, or solid iron.

Although the insulating substrates of the primary and secondary winding assemblies have been described as being formed of FR4, those of skill in the art will appreciate that other insulating material may be employed. For example, flex or rigid insulating substrates formed of polymide film may be employed. As will be appreciated, in this case a higher conductor trace concentration may be employed since polymide film has a higher dielectric strength than FR4.

Although polymide films have been described as overlying the solder masks, those of skill in the art will appreciate that other insulating material may be employed. For example, films or layers of other insulating material such as FR4, ceramic material or other laminate having suitable electrical insulating properties may be used.

Although embodiments have been described above with reference to the accompanying drawings, those of skill in the art will appreciate that variations modifications may be made without departing from the disclosure as defined by the appended claims.

What is claimed is:

1. A transformer comprising:
a core formed of magnetic material;
a primary printed circuit board (PCB) winding stack surrounding one limb of the core; and
a secondary PCB winding stack surrounding another limb of the core.

2. The transformer of claim 1, wherein the primary PCB winding stack comprises a plurality of stacked primary PCB winding assemblies electrically connected in series and wherein the secondary PCB winding stack comprises a plurality of stacked secondary PCB winding assemblies electrically connected in series.

3. The transformer of claim 2, wherein each primary PCB winding assembly comprises a plurality of generally planar winding layers and wherein the winding layers are electrically connected in parallel.

4. The transformer of claim 3, wherein the winding layers of each primary PCB winding assembly are configured to form a single turn coil.

5. The transformer of claim 4, wherein each primary PCB winding assembly comprises a plurality of layers formed of electrically insulating material on which the winding layers are disposed.

6. The transformer of claim 3, wherein the winding layers are substantially identical and have a high surface to volume ratio.

7. The transformer of claim 2, further comprising solder mask layers overlying opposite major surfaces of each stacked primary PCB winding assembly.

8. The transformer of claim 7, further comprising electrically insulating layers interposed between each pair of primary PCB winding assemblies in the primary PCB winding stack.

9. The transformer of claim 7, further comprising an electrically insulating layer on the uppermost and lowermost primary PCB winding assembly in the primary PCB winding stack.

10. The transformer of claim 3, wherein each secondary PCB winding assembly comprises a plurality of generally planar winding layers and wherein the winding layers are electrically connected in series.

11. The transformer of claim 10, wherein the winding layers of each secondary PCB winding assembly are configured to form a plural turn coil.

12. The transformer of claim 11, wherein each secondary PCB winding assembly comprises a layer formed of electrically insulating material and having a winding layer on each major surface thereof.

13. The transformer of claim 10, wherein the winding layers have a high surface to volume ratio.

14. The transformer of claim 10, further comprising solder mask layers overlying opposite major surfaces of each stacked secondary PCB winding assembly.

15. The transformer of claim 14, further comprising electrically insulating layers interposed between each pair of secondary PCB winding assemblies in the secondary PCB winding stack.

16. The transformer of claim 13, further comprising an electrically insulating layer on the uppermost and lowermost secondary PCB winding assembly in the secondary PCB winding stack.

17. The transformer of claim 1, wherein the transformer is configured to receive a 600V to 1 kV high frequency input and provide a 33 kV high frequency output.

18. The transformer of claim 1, wherein the transformer is of a compact form.

19. The transformer of claim 18, wherein the transformer has a length of about 7 inches, a width of about 4 inches and a height of about 4.5 inches.
